(19) United States
(12) Patent Application Publication
(10) Pub. No.: US 2017/0270782 A1
(43) Pub. Date: Sep. 21, 2017

(54) EVENT DETECTING METHOD AND ELECTRONIC SYSTEM APPLYING THE EVENT DETECTING METHOD AND RELATED ACCESSORY

(71) Applicant: MEDIATEK INC., Hsin-Chu (TW)

(72) Inventors: Tien-Ju Yang, Taichung City (TW); Liang-Che Sun, Taipei City (TW); Yu-Hao Huang, Kaohsiung City (TW); Chih-Kai Chang, Taichung City (TW); Chun-Chia Chen, Hsinchu City (TW); Tsung-Te Wang, Taipei City (TW)

(21) Appl. No.: 15/071,196

(22) Filed: Mar. 15, 2016

(51) Int. Cl. G08G 1/005; G08B 7/06

(52) U.S. Cl. CPC G08G 1/005; G08B 7/06

(57) ABSTRACT

Disclosed is an event detecting method, which is applied to an electronic system with at least one event detecting module. The event detecting method comprises: (a) enabling at least one event detecting module; and (b) applying the event detecting module enabled in the step (a) to detect if any predetermined event occurs in a detecting range of the event detecting module.

### BACKGROUND

Smart electronic devices such as a smart phone or a tablet computer become more and more popular recently. However, many users use these smart electronic devices when walking, even when riding or driving transportation. These users are always named “phubbers”. Such behaviors may causes dangers to the user, for example, falling, bumping into a pedestrian or other objects, or traffic accident.

Accordingly, an event detecting mechanism is needed to avoid these dangers.

### SUMMARY

One objective of the present application is to provide an event detecting method which can automatically detect surrounding events.

Another objective of the present application is to provide an event detecting system which can automatically detect surrounding events.

One embodiment of the present application provides an event detecting method, which is applied to an electronic system with at least one event detecting module. The event detecting method comprises: (a) enabling at least one event detecting module; (b) applying the event detecting module enabled in the step (a) to detect if any predetermined event occurs in a detecting range of the event detecting module; and(c) generating notification if the predetermined event occurs in the detecting range.

One embodiment of the present application provides an electronic system with an event detecting mechanism. The electronic system comprises: at least one event detecting module and a control module. The control module is configured to: enable at least one event detecting module; control the event detecting module which is enabled to detect if any predetermined event occurs in a detecting range of the event detecting module; and generate notification if the predetermined event occurs in the detecting range.

One embodiment of the present application discloses an accessory, comprising a plurality of microphones, wherein the microphones can couple to an electronic device and applied for determining a distance for an object.

In view of above-mentioned embodiments, the surrounding for the user can be detected even the user is phubbing. Accordingly, dangerous events can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating an event detecting method according to one embodiment of the present application.

FIG. 2, and FIG. 4 are schematic diagram illustrating the operations for the event detecting method according to one embodiment of the present application.

FIG. 3(a), FIG. 3 (b) are examples for the operations illustrated in FIG. 2.

FIG. 5(a) and FIG. 5(b) are schematic diagrams illustrating the locations of lens according to one embodiment of the present application.

FIG. 6(a) and FIG. 6(b) are schematic diagrams illustrating operations for an audio detecting module according to one embodiment of the present application.

FIG. 7(a) and FIG. 7(b) are schematic diagrams illustrating the audio detecting module according to one embodiment of the present application.

FIG. 8 is a schematic diagram illustrating an electronic system according to one embodiment of the present application.

FIG. 9 is a block diagram illustrating an electronic system according to another embodiment of the present application.

### DETAILED DESCRIPTION

In the following, several embodiments are provided to explain the concept of the present application. It will be appreciated that the system, the device, the apparatus or the module depicted in following embodiments can be implemented by hardware (ex. circuit) or the combination of hardware and software (ex. a processing unit executing at least one program). Also, in the following embodiments, the term “event” can mean an object or sound exists in a detecting range.

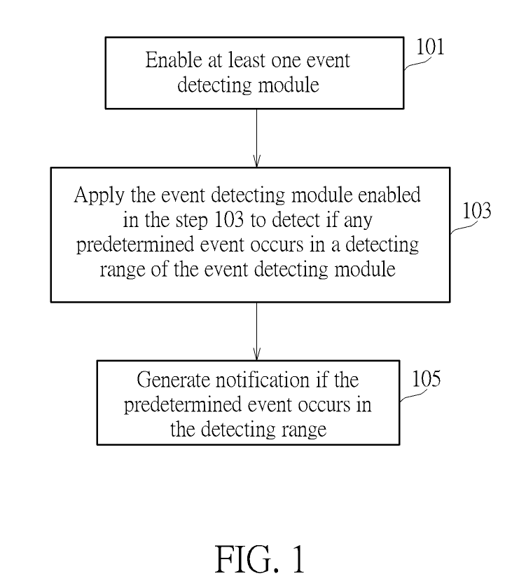

FIG. 1 is a flow chart illustrating an event detecting method according to one embodiment of the present application. The event detecting method is applied to an electronic system comprising at least one event detecting module. The event detecting method comprises following steps:

Step 101

Enable at least one event detecting module.

Step 103

Apply the event detecting module enabled in the step 103 to detect if any predetermined event occurs in a detecting range of the event detecting module. That is, detect if any predetermined event occurs in a surrounding area of the event detecting module.

Step 105

Generate notification if the predetermined event occurs in the detecting range.

Details for each step will be described in the following.

Regarding to the step 101, in one embodiment, at least one of the event detecting modules is initially disabled. Also, at least one of the disabled event detecting module(s) is enabled according to if any specific enabling event occurs. In one embodiment, the specific enabling event comprises but not limited to at least one of following events: the electronic system is in a specific region, the electronic system is moving. For example, in one embodiment, the electronic system comprises an accelerometer configured to detect if the user is walking or moving, for example, in a high speed. In another embodiment, the electronic system comprises a GPS to detect if the electronic system is in a dangerous region or if the user is walking or moving.

Regarding to the step 103, in one embodiment, the predetermined event comprises at least one of: an obstacle exists in the detecting range (ex. electric pole), a stair or a hole exists in the detecting range, a sign with warning information exists in the detecting range (ex. a caution sign), an object is approaching (ex. a car or a pedestrian), and a traffic light in the detecting range changes or will change. In one embodiment, the predetermined event means the event that maybe dangerous for the user. For example, an obstacle exists in the detecting range, a stair or a hole exists in the detecting range, an object is approaching. In another embodiment, the predetermined event means the event that the user should pay attention, for example, a sign with warning information exists in the detecting range, a traffic light in the detecting range changes or will change.

Many methods can be applied to detect these predetermined events. In one embodiment, the shape of the event is detected to determine if the event is the predetermined event. For example, detect the shape of an object to determine if this object is an obstacle such as a trash can or an electric pole. In another example, the color of the event is detected to determine if the event is the predetermined event. For example, if an object is red, it might be a traffic light. In another embodiment, the shape and the color of the event are both detected. It will be appreciated the methods for detecting these predetermined events are not limited to above-mentioned examples.

As above-mentioned description, many methods can be applied to detect these predetermined events. Accordingly, different types of devices can be implemented as the event detecting module. In one embodiment, the event detecting module comprises at least one of: an image capturing module and a depth detecting module.

The image capturing module can be, for example, a RGB camera, a night vision camera or an infrared camera. The image capturing module is configured to capture an image, and the event can be determined if it is a predetermined event according to the image. The depth detecting module is configured to detect depth information such as depth map for the event.

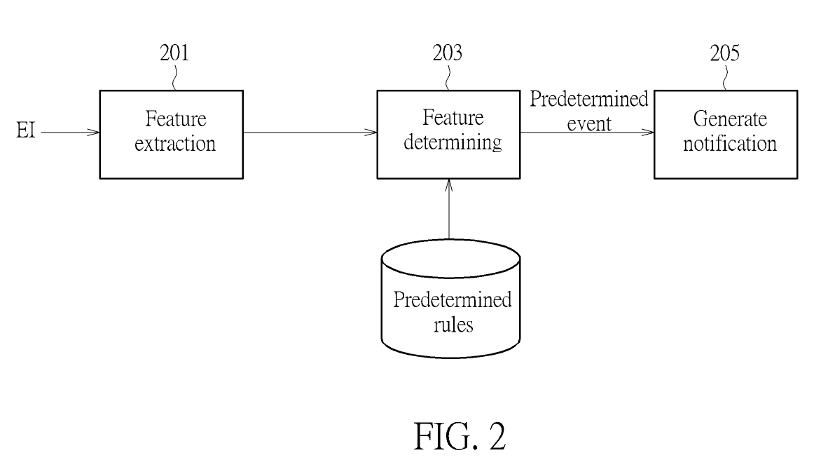

FIG. 2 is a schematic diagram illustrating the operations for the event detecting method according to one embodiment of the present application. As illustrated in FIG. 2, the event information EI is acquired and features thereof are extracted (step 201). In the embodiment that the event detecting module comprises an image capturing module, the event information EI is an image. Also, in the embodiment that the event detecting module comprises an image capturing module and a depth detecting module, the event information EI is an image with depth information. The step 203 determines if the features match predetermined rules. After that, if the features match predetermined rules, the corresponding event is determined as a predetermined event and the step 205 is performed to generate notification (i.e. the step 105 in FIG. 1).

Many protocols can be applied for the feature extraction (step 201), for example, scale invariant feature transform (SIFT), Haar-like features, learned features (ex. convolutional neural network). Also, the predetermined rules can be predetermined patterns or pre-trained models such as support vector machine, adaptive boosting, and deep neural net.

In one embodiment, the event is determined according to audible sound (ex. sound has a frequency smaller than 20 KHz). In such case, the model can be trained using machine learning approaches such as Gaussian mixture model (GMM), Hidden Markov Model (HMM), Deep Neural Net (DNN). Also, in such embodiment, the algorithm for determining if features of the event match the model or not may be viterbi algorithm for HMM.

Also, in one embodiment, only a part of all models are selected for the predetermined rules according to specific information, to speed up processing and increase accuracy. For example, apply GPS data to know the possible objects which could appear in the current position and only use the corresponding models.

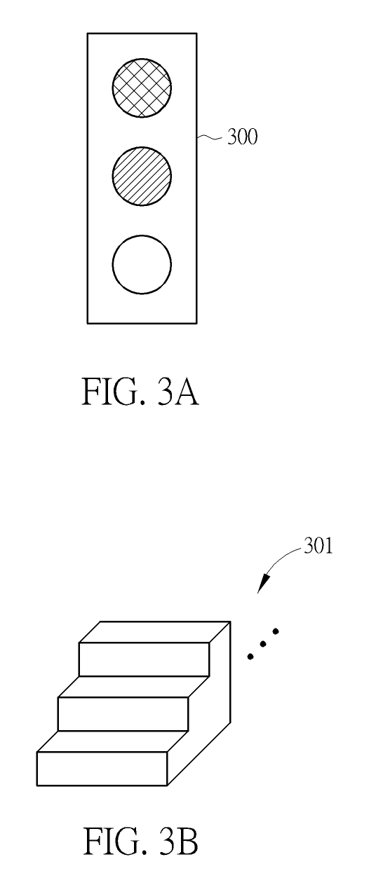

FIG. 3(a), FIG. 3(b) are examples for the operations illustrated in FIG. 2. In FIG. 3(a), if an image for the traffic light 300 is captured, it can be recognized as a traffic light since the image contains three circles and three kinds of light (ex. red, yellow and green). In FIG. 3(b), if an image for the stair 301 is captured, it can be recognized as a stair since the image contains many stages and corners. Please note these examples are only for explaining and do not mean to limit the scope of the present application.

FIG. 4 is a schematic diagram illustrating the operations for the event detecting method according to one embodiment of the present application. In this embodiment, the step for determining if the event is the predetermined event or not is performed according to the depth information rather than the shape or color. As illustrated in FIG. 4, the event information EI, which comprises depth information and at least one image is acquired, and then the depth information for the object in the image is segmented from the whole image. After that, the distance and/or speed for the object can be acquired according to the depth information (step 403). Thereafter, if the distance and/or speed for the object matches a predefined rule, it is determined that the predetermined event occurs, thus notification is generated (step 405, which is the step 103 in FIG. 1).

The above-mentioned image capturing module or depth detecting module always comprises at least one lens. In one embodiment, the lens can be provided at a specific location of the electronic system, such that the image for the surroundings for the electronic system can be clearly captured even if the user is phubbing.

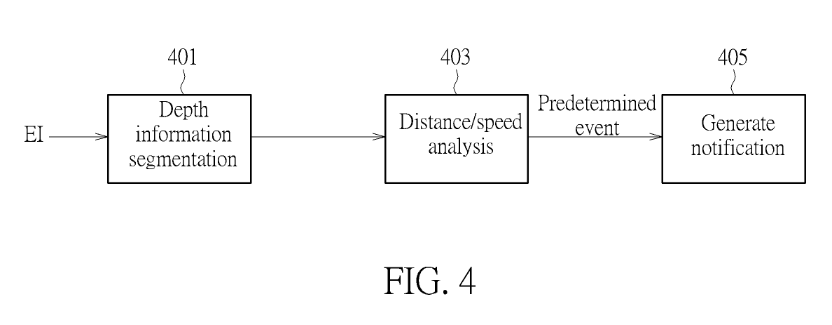

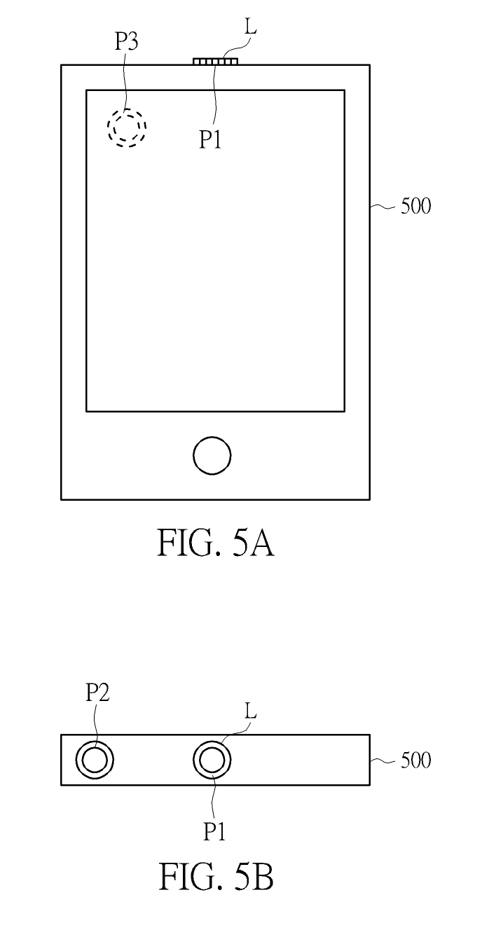

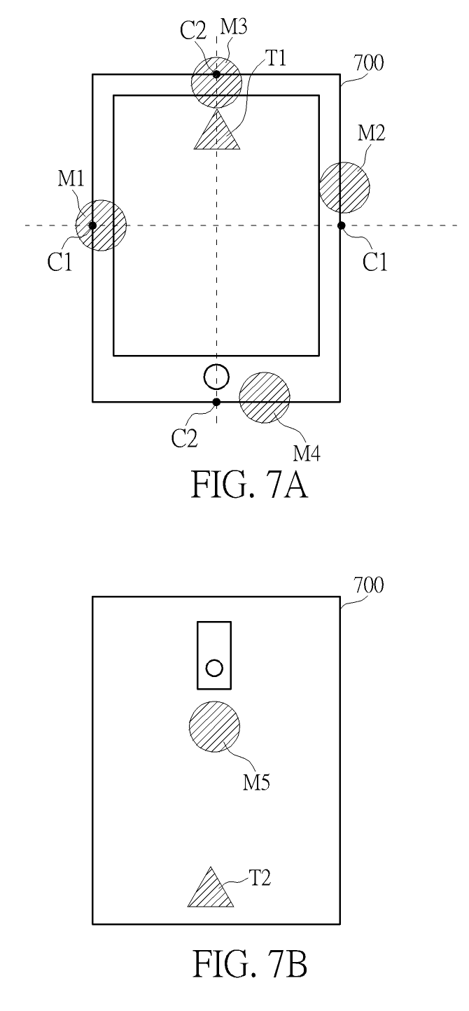

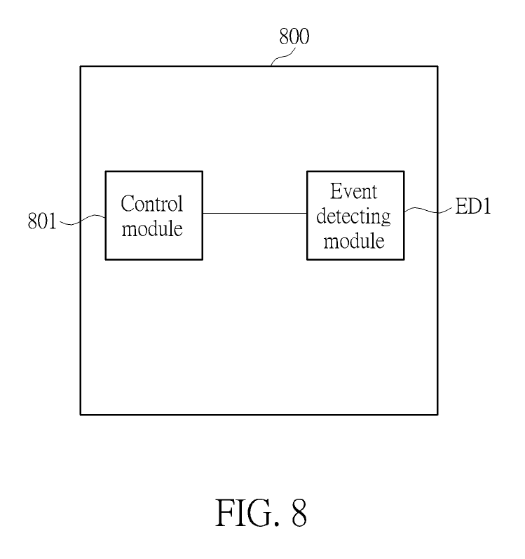

FIG. 5(a) and FIG. 5(b) are schematic diagrams illustrating the locations of lens according to one embodiment of the present application. FIG. 5(b) is a top view of FIG. 5(a). As illustrated in FIG. 5(a), the lens L is provided at a top part of the electronic system 500. Via applying the embodiment of FIG. 5(a) and FIG. 5(b), the image or the depth information for the surroundings of the electronic system can be clearly acquired even if the user is phubbing. Please note the lens L is not limited to be provided at the location P1 illustrated in FIG. 5(a) and FIG. 5(b), the lens L can be provided at the locations P2 and P3 as well. In other words, the concept of the FIG. 7(a) and FIG. 7(b) is that the lens can be provided a location that can detect event even if the user is using the electronic system 500.

In one embodiment, the event detecting module comprises an audio detecting module, which is configured to detect a location of an object according to audible sound or ultrasound.

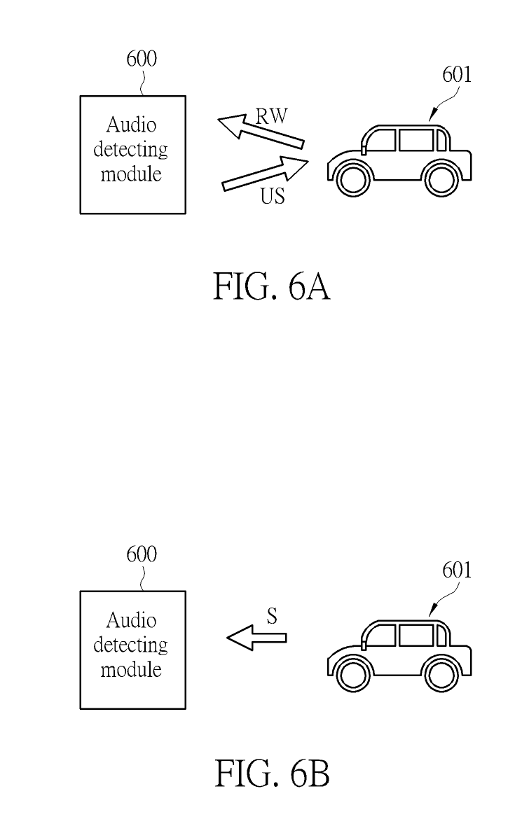

FIG. 6(a) and FIG. 6(b) are schematic diagrams illustrating operations for an audio detecting module according to one embodiment of the present application. As illustrated in FIG. 6(a), the audio detecting module 600 generates ultrasound US to an object 601, and the object 601 accordingly generates reflected wave RW. By this way, the location of the object 601 can be determined according to the reflected wave RW, thus the distance and/or speed of the object 601 can be correspondingly acquired. Besides, in the embodiment of FIG. 6(b), the audio detecting module 600 receives audible sound S from the object 601, and determines the distance and/or speed of the object 601 according to the audible sound S. In one embodiment, the audio detecting module 600 collects the features via reflected wave RW or audible sound S and may further check the distance between the device and at least one nearest object.

In one embodiment, the audio detecting module 600 receives the reflected wave RW or the audible sound S via a microphone array, and generates a specific sound (for example, the ultrasound US) via a transducer array, but not limited.

The operations for the audio detecting module can be described via FIG. 2 as well. Please refer to FIG. 2 again, the event information EI is acquired and features thereof are extracted (step 201). However, the event information EI is audible sound or reflected wave rather an image. The step 203 determines if the features match predetermined rules. After that, if the features match predetermined rules, the corresponding event is determined as a predetermined event and the step 205 is performed to generate notification (i.e. the step 105 in FIG. 1).

In such embodiment, if the event information EI is audible sound, the step 201 can be implemented by an audio feature extracting protocol such as mel-frequency cepstral coefficient. Also, if the event information EI is ultrasound, the step 201 can be implemented by sub-band analysis such as fast Fourier transform or wavelet. Further, in such embodiment, the predetermined rules can be patterns or models for moving objects, (ex. car) or reflection patterns or models of fixed objects (ex. wall).

In one embodiment, the audio detecting module comprises at least one microphone and/or at least one transducer. The locations and/or numbers for the microphone and the transducer can be particularly designed to assist detecting of the audio detecting module. For example, if the audio detecting module comprises only one microphone, the audio detecting module can detect audible sound/ultrasound. Also, if the audio detecting module comprises 3 or more microphones, the audio detecting module can detect the 3D location of the object. Besides, if the audio detecting module comprises 5 or more microphone, the audio detecting module can have a more precise performance.

FIG. 7(a) and FIG. 7(b) are schematic diagrams illustrating the audio detecting module according to one embodiment of the present application. FIG. 7(a) is a front view for an electronic system 700, and FIG. 7(b) is a back view for the electronic system 700. AS illustrated in FIG. 7(a), the audio detecting module comprises microphones M1, M2, M3 and M4 and a transducer T1. The microphones M1, M2 are respectively provided at a left side and a right side of the electronic system 700. Also, the microphones M3, M4 are respectively provided at a top side and a bottom side of the electronic system 700. In one embodiment, the locations for the microphones Ml, M2 are not symmetric. In other words, a relation between a location of the microphone M1 and the left side, and a relation between a location of the microphone M2 and the right side are different. For example, the microphone M1 is at a center location C1 for the left side of the electronic system 700, but the microphone M2 is at a location higher than a center location C1 for the right side of the electronic system 700.

Similarly, in one embodiment, the locations for the microphones M3, M4 are not symmetric. In other words, a relation between a location of the microphone M3 and the top side, and a relation between a location of the microphone M4 and the bottom side are different. For example, the microphone M3 is at a center location C2 for the top side of the electronic system 700, but the microphone M4 is at a location on the right of a center location C2 for the bottom side of the electronic system 700.

As above-mentioned, FIG. 7(b) is a back view for the electronic system 700. In one embodiment, the electronic system 700 further comprises a microphone M5 and a transducer T2 provided at the back side of the electronic system 700. In one embodiment, different transducers, such as T1 and T2, can produce same or different sound for detecting the object.

In view of the embodiments illustrated in FIG. 7(a) and FIG. 7(b), distances between microphones and each transducer in FIG. 7(a) and FIG. 7(b) may be different. For example, the distance between the microphone M1 and the transducer T1 and the distance between the microphone M2 and the transducer T1 are different. Accordingly, the positions of the microphones M1, M2 and the transducer T1 may form a non- equilateral triangle. Similarly, the distance between the microphone M3 and the transducer T2 and the distance between the microphone M4 and the transducer T2 are different. Accordingly, the positions of the microphones M3, M4 and the transducer T2 may form a non- equilateral triangle.

In some other embodiments, distances between transducers and each microphone in FIG. 7(a) and FIG. 7(b) may be different. For example, the distance between the microphone M1 and transducers T1 and the distance between the microphone M1 and the transducer T2 are different. Similarly, the distance between the microphone M3 and transducers T1 and the distance between the microphone M3 and the transducer T2 are different.

The microphones illustrated in FIG. 7(a), FIG. 7(b) can be provided to the electronic system 700 via directly setting the microphones on the electronic system 700 or via a removable accessory such as protecting case. Such accessory can be regarded as: An accessory, comprising a plurality of microphones (ex. M1, M2, or M3, M4 in FIG. 7(a) and FIG. 7(b)). The microphones can couple to an electronic device (ex. the electronic system 700) through a wireless connection (ex. a wireless network connection, Bluetooth or any other wireless connection) and applied for determining a distance for an object (ex. the operations illustrated in FIG. 6(a) and FIG. 6(b).

In one embodiment, the accessory comprises a case (ex. the above-mentioned protecting case). The microphones are located on the case. Positions of two of the microphones and a transducer of the electronic device may form a non- equilateral triangle if the case is mounted to the electronic device.

Additionally, in another embodiment, the microphones are fixed to the electronic device via at least one fastener such as screws.

If the image capturing module comprises more than one type of camera, a proper type of camera can be automatically selected according to statuses for the environment surrounding the user. For example, according to a light sensor, when the illumination is good enough, use the RGB camera. Oppositely, when the illumination is poor, use the night vision camera. Also, if the illumination is very poor, use the audio camera.

Please refer to FIG. 1 again, regarding to the step 105, in one embodiment, the notification comprise at least one of: lowering a volume of the electronic system, playing a volume of the event via the electronic system, marking an object related with the event, showing a notifying message via the electronic system, vibrating the electronic system, and changing a color displayed by the electronic system.

For example, if the user is listening to music by an earphone and the event detecting module detects a car is approaching, the electronic system lowers the volume of music such that the user can listen to sound of the car. In another example, the event detecting module detects some sound meeting the predetermined event (ex. whistle of an ambulance), the electronic system plays the sound loudly via the electronic system, such that the user can take notice of it. For such example, in one embodiment, the volume of a pre-trained audio event is enhanced and played by the speaker of the electronic device. In another embodiment for such example, a pre-defined notice sound may be played by the speaker of the electronic device.

In still another example, the event detecting module detects an image that may meet the predetermined event (ex. a traffic light), the electronic system displays the image and marks an object related with the event, such that the user can check this event.

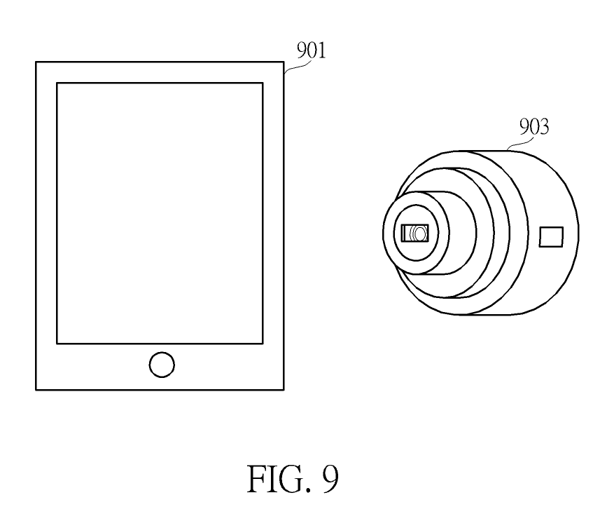

FIG. 8 is a schematic diagram illustrating an electronic system with an event detecting mechanism according to one embodiment of the present application. As illustrated in FIG. 8, the electronic system 800 comprises at least one event detecting module ED1 (only one is illustrated in this embodiment) and a control module 801. The control module 801 is configured to: enable at least one event detecting module; control the event detecting module which is enabled to detect if any predetermined event occurs in a detecting range of the event detecting module; and generate notification if the predetermined event occurs in the detecting range. Please note, in one embodiment, the event detecting module only detects the event, and the function of determining if the event is a predetermined event is performed by the control module 801. It will be appreciated that in one embodiment the event detecting module is excluded from the electronic system 800, such that the electronic system 800 only comprises the control module 801.

Please note, in above-mentioned embodiments, the control module and the event detecting modules are provided in a single electronic device such as a mobile phone. However, the control module and the event detecting modules can be provided in different electronic devices. FIG. 9 is a schematic diagram illustrating an electronic system according to one embodiment of the present application. As illustrated in FIG. 9, the control module is in the electronic device 901 (not illustrated), and the event detecting module comprises a portable camera 903, which is applied to capture an image and wirelessly transmits the image to the electronic device 901. Please note, the portable camera 903 can be replaced by any other type of electronic device. For example, the portable camera 903 can be replaced by a wearable device such as a smart glass. Therefore, the user can put the event detecting module at any location, for example, put on the backpack. By this way, the event can be detected even if it occurs behind the user.

In view of above-mentioned embodiments, the surrounding for the user can be detected even the user is phubbing. Accordingly, dangerous events can be avoided. Also, a proper event detecting module can be selected according to status for the environment surrounding the user. Besides, the predetermined rules can be determined by only a part of all models rather than all models, which are selected according to specific information to speedup processing and to increase accuracy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An event detecting method, applied to an electronic system with at least one event detecting module, comprising:
(a) enabling at least one event detecting module; and
(b) applying the event detecting module enabled in the step(a)to detect if any predetermined event occurs in a detecting range of the event detecting module.

2. The event detecting method of claim 1, wherein the step (a) enables the at least one event detecting module according to if any specific enabling event occurs.

3. The event detecting method of claim 2, wherein the specific enabling event comprises at least one of following events: the electronic system is in a specific region, and the electronic system is moving.

4. The event detecting method of claim 1, wherein the event detecting module comprises at least one of: a depth detecting module and an image capturing module.

5. The event detecting method of claim 1, wherein the event detecting module comprises an audio detecting module configured to detect a location of an object.

6. The event detecting method of claim 1, wherein the predetermined event comprises at least one of: an obstacle exists in the detecting range, a stair or a hole exists in the detecting range, a sign with warning information exists in the detecting range, an object is approaching, and a traffic light in the detecting range changes or will change.

7. The event detecting method of claim 1, further comprising: generating notification if the predetermined event occurs in the detecting range.

8. The event detecting method of claim 7, wherein the notification comprise at least one of: lowering a volume of the electronic system, playing a volume of the event via the electronic system, marking an object related with the event, showing a notifying message via the electronic system, vibrating the electronic system, and changing a color displayed by the electronic system.

9. An electronic system with an event detecting mechanism, comprising:
a control module, configured to:
enable at least one event detecting module; and
control the event detecting module which is enabled to detect if any predetermined event occurs in a detecting range of the event detecting module.

10. The electronic system of claim 9, wherein the control module enables the at least one event detecting module according to if any specific enabling event occurs.

11. The electronic system of claim 10, wherein the specific enabling event comprises at least one of following events: the electronic system is in a specific region, and the electronic system is moving.

12. The electronic system of claim 9, wherein the event detecting module comprises at least one of: a depth detecting module and an image detecting module.

13. The electronic system of claim 12, wherein the image detecting module and/or the depth detecting module comprises a lens provided at a top part of the electronic system.

14. The electronic system of claim 9, wherein the event detecting module comprises an audio detecting module configured to detect a location of an object.

15. The electronic system of claim 14, wherein the audio detecting module comprises a transducer, a first microphone and a second microphone, wherein a distance between the transducer and the first microphone and a distance between the transducer and the second microphone are different.

16. The electronic system of claim 9, wherein the predetermined event comprises at least one of: an obstacle exists in the detecting range, a stair or a hole exists in the detecting range, a sign with warning information exists in the detecting range, an object is approaching, and a traffic light in the detecting range changes or will change.

17. The electronic system of claim 9, wherein the control module generates notification if the predetermined event occurs in the detecting range

18. The electronic system of claim 17, wherein the notification comprise at least one of : lowering a volume of the electronic system, playing a volume of the event via the electronic system, marking an object related with the event, showing a notifying message via the electronic system, vibrating the electronic system, and changing a color displayed by the electronic system.

19. The electronic system of claim 9, wherein the event detecting module and the control module are provided in different electronic devices.

20. An accessory, comprising a plurality of microphones, wherein the microphones can couple to an electronic device and applied for determining a distance for an object.

21. The accessory of claim 20, wherein the accessory comprises a case, wherein the microphones are located on the case, wherein positions of two of the microphones and a transducer of the electronic device form a non- equilateral triangle if the case is mounted to the electronic device.

22. The accessory of claim 20, wherein the microphones are fixed to the electronic device via at least one fastener.
